(19) United States
(12) Patent Application Publication
(10) Pub. No.: US 2022/0067661 A1
(43) Pub. Date: Mar. 3, 2022

(54) SYSTEMS AND METHODS FOR ADVANCED WORKFLOWS

(71) Applicant: Venminder, Inc., Elizabethtown, KY (US)

(72) Inventor: Dana A. Bowers, Elizabethtown, KY (US)

(21) Appl. No.: 17/410,439

(22) Filed: Aug. 24, 2021

Related U.S. Application Data
(60) Provisional application No. 63/071,680, filed on Aug. 28, 2020.

(51) Int. Cl. G06Q 10/10; G06Q 40/02; G06Q 40/08; G06F 9/451

(52) U.S. Cl. CPC G06Q 10/103; G06Q 40/02; G06Q 30/018; G06F 9/451; G06Q 10/1093; G06Q 40/08

(57) ABSTRACT

Methods and systems are presented herein for managing advanced workflows with one or more vendors and/or their products or services for financial institutions.

### CROSS-REFERENCE TO RELATED APPLICATIONS

This application claims priority to and the benefit of U.S. Provisional Patent Application Ser. No. 63/071,680, filed Aug. 28, 2020, entitled “SYSTEMS AND METHODS FOR ADVANCED WORKFLOWS,” the disclosure of which is incorporated herein by reference in its entirety.

### FIELD OF THE INVENTION

This invention relates generally to systems and methods for managing client/vendor relationships. More particularly, in certain embodiments, the invention relates to systems and methods for providing vendor and agreement management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields.

### SUMMARY

Methods and systems are presented herein for adding, to a vendor management system, information relating to one or more (new) vendors providing services and/or other products to the financial institution resulting in a consolidated, efficient system for managing contracts between a financial institution and its vendors.

In one aspect, the invention is directed to a method for managing one or more vendors and/or products. The method includes causing to display, by a processor of an enterprise system, one or more graphical user interfaces (GUIs) associated with one or more workflow management modules. The method includes receiving, by the processor of the enterprise system, a first input (e.g., received via a graphical user interface widget) from a first client user (e.g., said first client user having been authorized to access the enterprise system, e.g., said first client user being one member of a network of subscribed clients), the first input comprising instructions to access a workflow management GUI. The method includes receiving, by the processor of the enterprise system, (e.g., received via a graphical user interface widget) data field information related to said vendor and/or product. The method includes updating, in a memory of the enterprise system, vendor and/or product information stored in association with the first client, based on the subsequent input. The workflow management module is configured to produce and edit one or more vendor management workflow programs.

The subsequent input may include data field information for adding a step to a workflow. The step may be a template step. The step may be or may include a send questionnaire step. The workflow may be or may include an onboarding workflow. The workflow management module may be user activated. The method may include downloading a workflow.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example Sales & Contracting: New Sale GUI in accordance with an embodiment of the invention.

FIG. 18 is an example Customer Order Details GUI in accordance with an embodiment of the invention.

FIG. 19 is an example Admin Panel: User Roles—Custom Roles GUI in accordance with an embodiment of the invention.

FIG. 20 is an example Admin Panel: Advanced Workflows Tab GUI in accordance with an embodiment of the invention.

FIG. 21 is an example Advanced Workflows: Templates GUI in accordance with an embodiment of the invention.

FIG. 22 is an example Manage Workflows GUI in accordance with an embodiment of the invention.

FIG. 23 is an example Manage Workflows GUI with Add Workflow button in accordance with an embodiment of the invention.

FIG. 24 is an example Workflow Criteria—Recurring Workflow Criteria GUI in accordance with an embodiment of the invention.

FIG. 25 is an example Workflow Criteria—Non-Recurring Workflow Criteria GUI in accordance with an embodiment of the invention.

FIG. 26 is an example Vendor Onboarding Workflow Criteria GUI in accordance with an embodiment of the invention.

FIG. 27 is an example Workflow Criteria GUI as activated by the Workflow Criteria link/pencil in accordance with an embodiment of the invention.

FIG. 28 is an example Delete workflow widget to delete template and associated workflows in accordance with an embodiment of the invention.

FIG. 29 is an example Delete workflow widget to delete template with no associated workflows triggered in accordance with an embodiment of the invention.

FIG. 30 is an example Workflow template: Move workflow step widget in accordance with an embodiment of the invention.

FIG. 31 is an example Workflow template: Move option not available widget in accordance with an embodiment of the invention.

FIG. 32 is an example Workflow template: Add step GUI in accordance with an embodiment of the invention.

FIG. 33 is an example Add template step for non-onboarding workflow GUI in accordance with an embodiment of the invention.

FIG. 34 is an example Add template step for onboarding workflow GUI in accordance with an embodiment of the invention.

FIG. 35 is an example Edit Send questionnaire GUI in accordance with an embodiment of the invention.

FIG. 36 is an example Questionnaire options GUI in accordance with an embodiment of the invention.

FIG. 37 is an example Onboarding Workflow Template: Edit Assignment GUI in accordance with an embodiment of the invention.

FIG. 38 is an example Onboarding Settings: Section Approval Override Warning widget in accordance with an embodiment of the invention.

FIG. 39A is an example Edit Step widget with Delete button in accordance with an embodiment of the invention. FIG. 39B is an example Delete workflow steps widget in accordance with an embodiment of the invention.

FIG. 40 is an example Activate Workflow GUI in accordance with an embodiment of the invention.

FIG. 41 is an example Workflow GUI widget with a workflow activation indicator in accordance with an embodiment of the invention.

FIG. 42 is an example Deactivate Workflow GUI in accordance with an embodiment of the invention.

FIG. 43 is an example Delete workflow steps GUI FIG. 44 is an example Manage Workflows GUI with Download Active Workflows button in accordance with an embodiment of the invention.

FIG. 45 is an example Main Dashboard: Advanced Workflows Widget for NON-Admins GUI in accordance with an embodiment of the invention.

FIG. 46 is an example Main Dashboard: Advanced Workflows Widget for Admins GUI in accordance with an embodiment of the invention.

FIG. 47 is an example Advanced Workflows Widget Expanded View for Admins GUI in accordance with an embodiment of the invention.

FIG. 48 is an example Product Workflow Status widget in accordance with an embodiment of the invention.

FIG. 49 is an example Workflows Tab GUI in accordance with an embodiment of the invention.

FIG. 50 is an example Vendor Dashboard: Active workflow display GUI in accordance with an embodiment of the invention.

FIG. 51 is an example Vendor Dashboard: Edit Workflow Step GUI in accordance with an embodiment of the invention.

FIG. 52 is an example Workflow Step: Approval History in Comments GUI in accordance with an embodiment of the invention.

FIG. 53 is an example Vendor Dashboard Report GUI in accordance with an embodiment of the invention.

FIG. 54 is an example Questionnaires: Questionnaire Library GUI in accordance with an embodiment of the invention.

FIG. 55 is an example Delete Questionnaire GUI in accordance with an embodiment of the invention.

FIG. 56 is an example Workflow window with Onboarding Workflow GUI in accordance with an embodiment of the invention.

FIG. 57 is an example Status Tab workspace with a Kick off Workflow button in accordance with an embodiment of the invention.

FIG. 58 is a block diagram of an example network environment for use in the methods and systems for analysis of spectrometry data, according to an illustrative embodiment.

FIG. 59 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors.

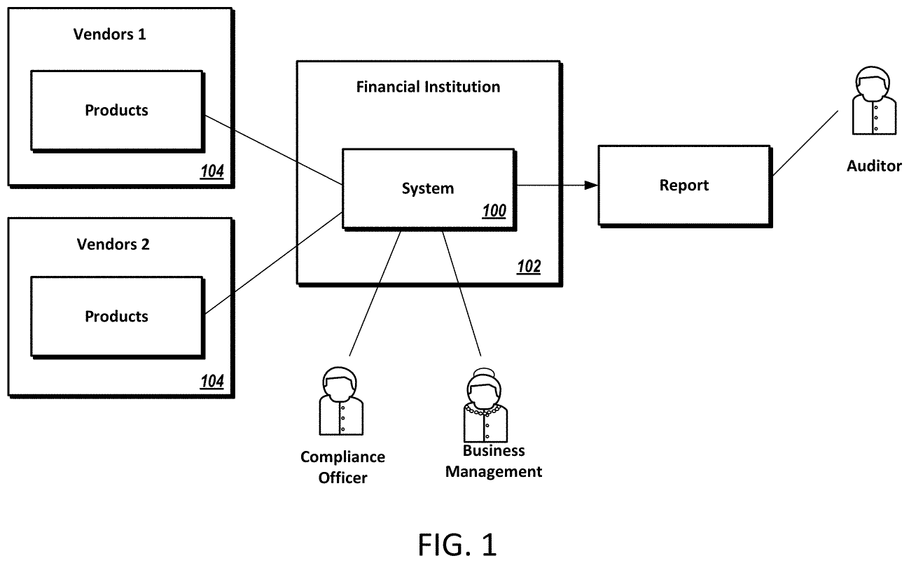

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

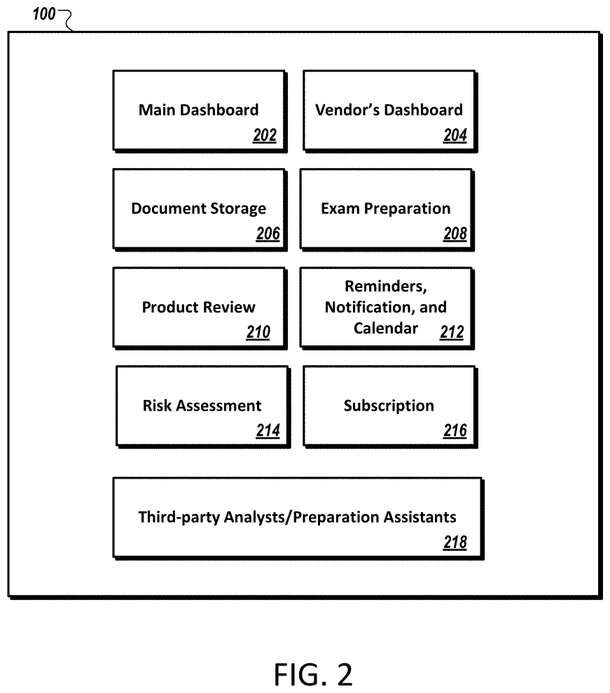

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

Main Dashboard

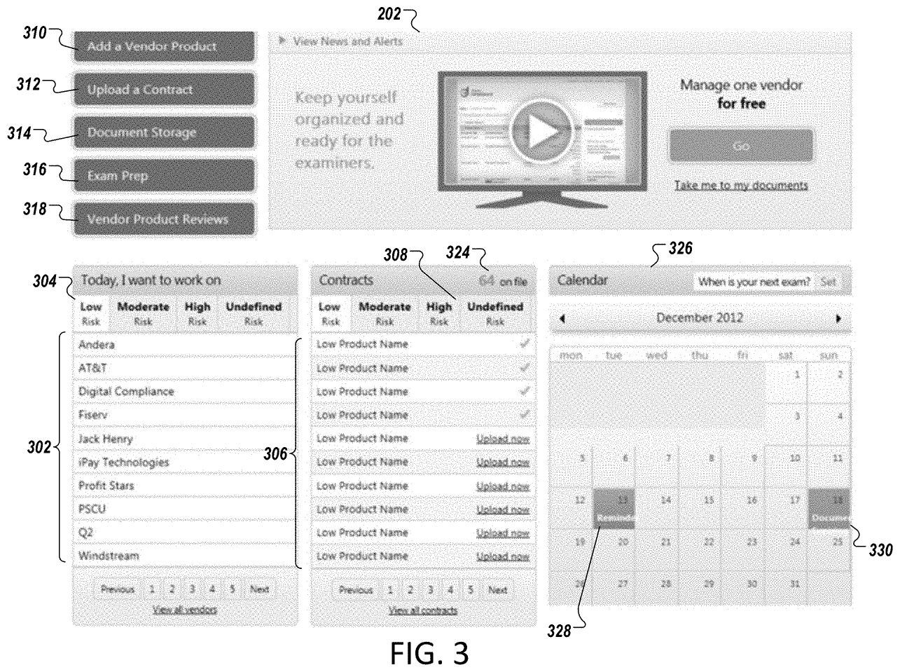

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

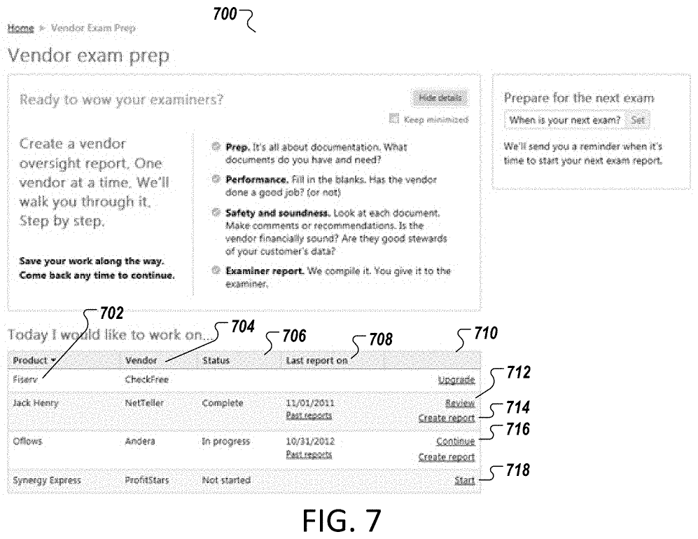

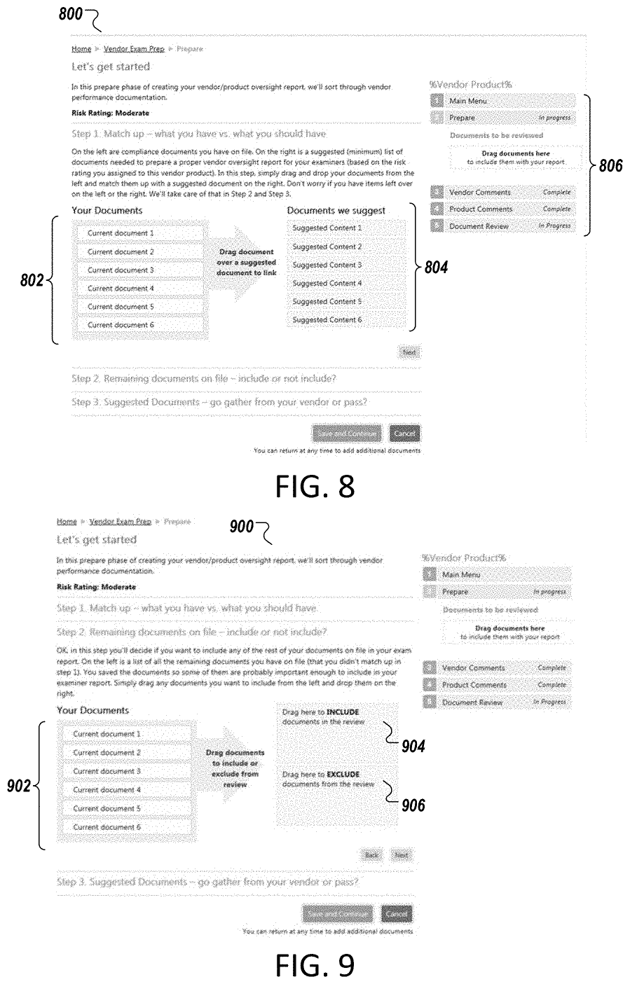

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

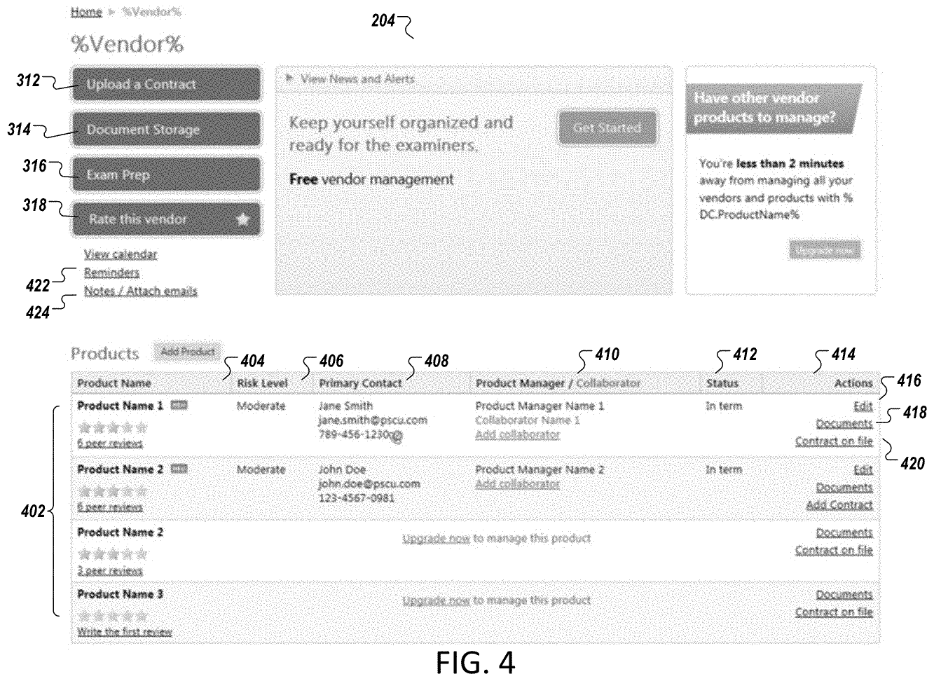

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

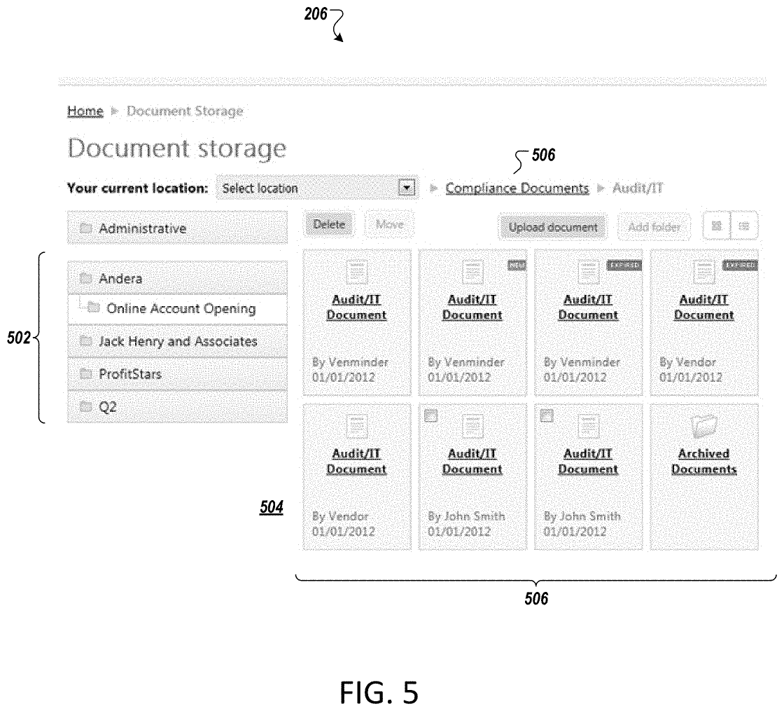

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

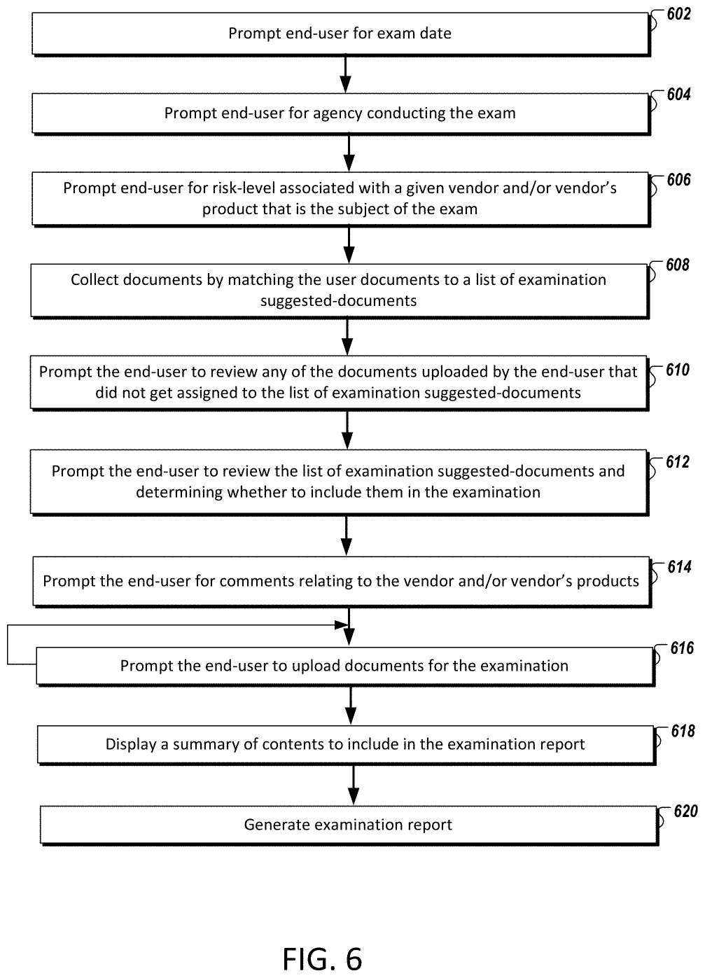

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps completed | Continue, Preview report |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

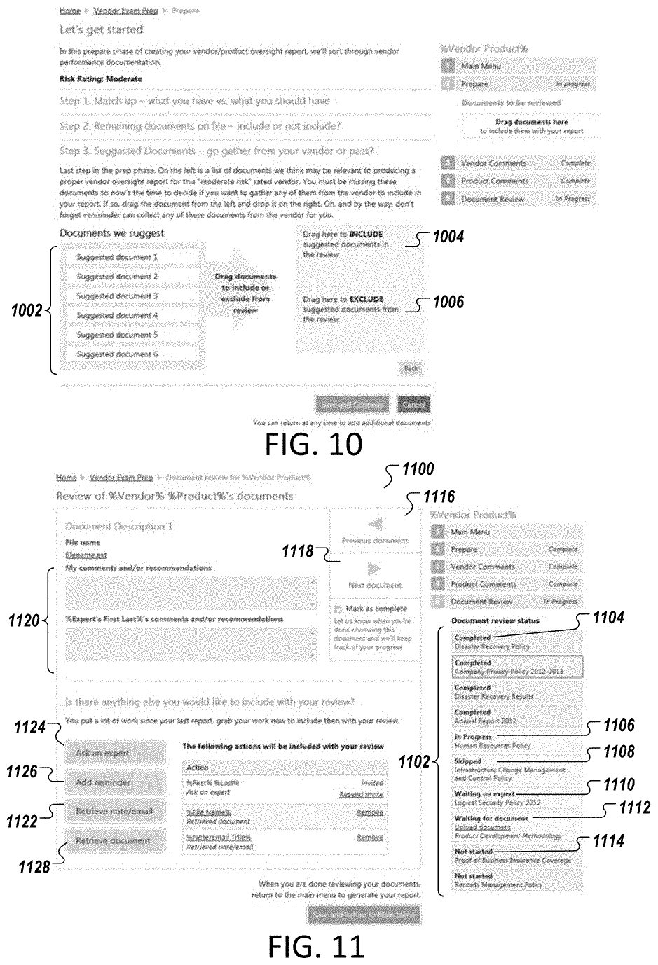

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for | Document type is included in exam but document |
| documents | has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

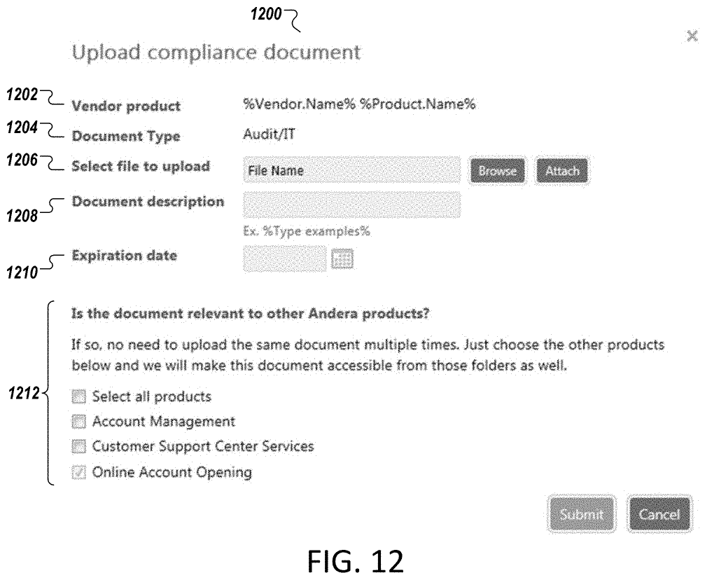

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be included in the report.

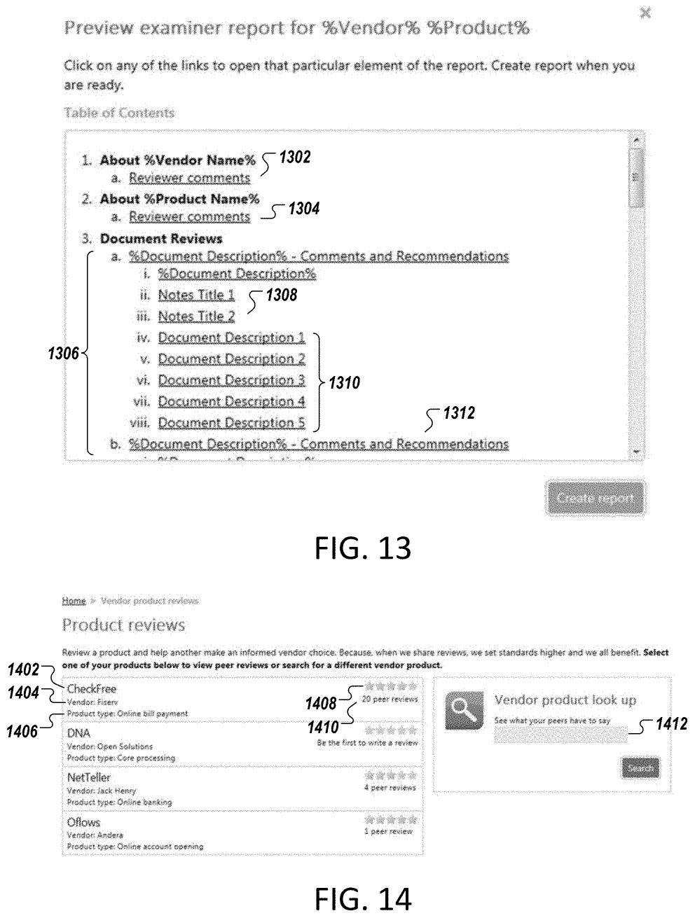

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

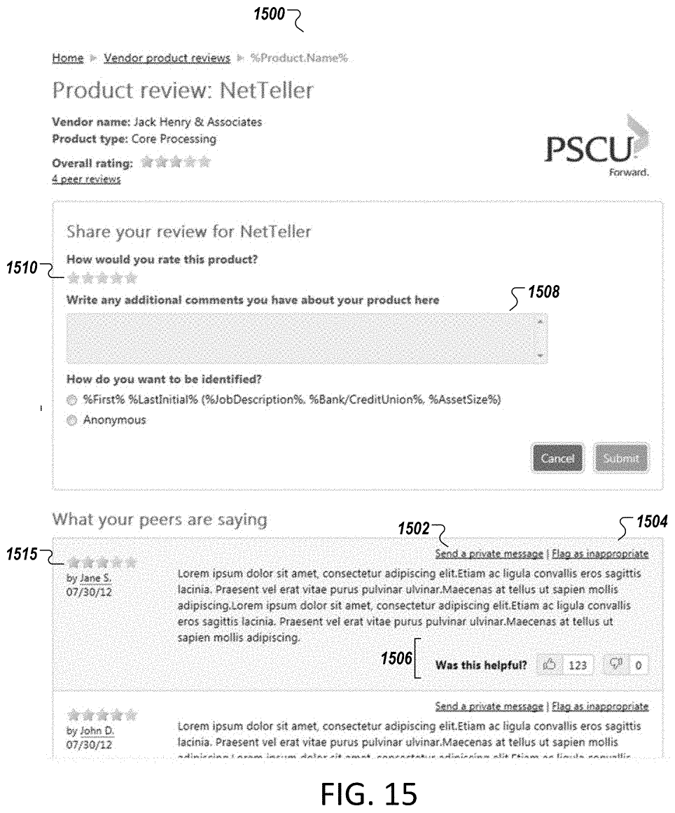

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

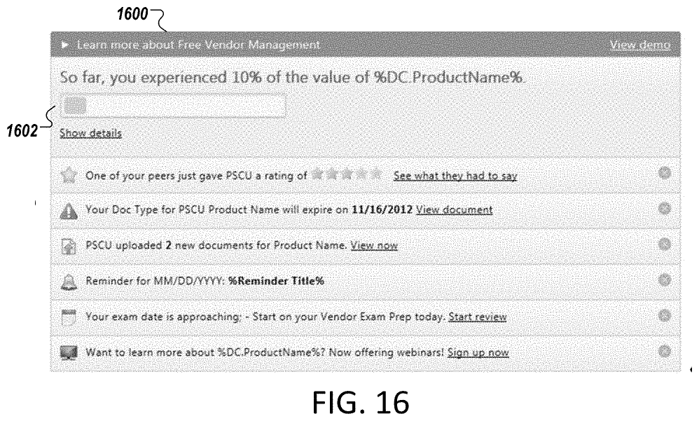

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

Advanced Workflows

A system as described in this specification may include an Advanced Workflows module. This module may help users (e.g., client users) drive process consistency by allowing the users to define and automate required activities or tasks using rule-based logic.

The Advanced Workflows module may ensure that a team of users is closely aligned to defined processes and provides structure in how, when, and who should perform certain actions. The team users may follow a series of automated actions that can trigger additional actions as they progress through the workflow. Approvals can be required along the way. A system may include pre-built workflow templates to help clients adopt the functionality quickly.

Benefits of Advanced Workflows include the capability to drive process consistency with automated direction, configure to suit processes, and build efficiencies and streamline a client's entire program

Digital Compliance Administration

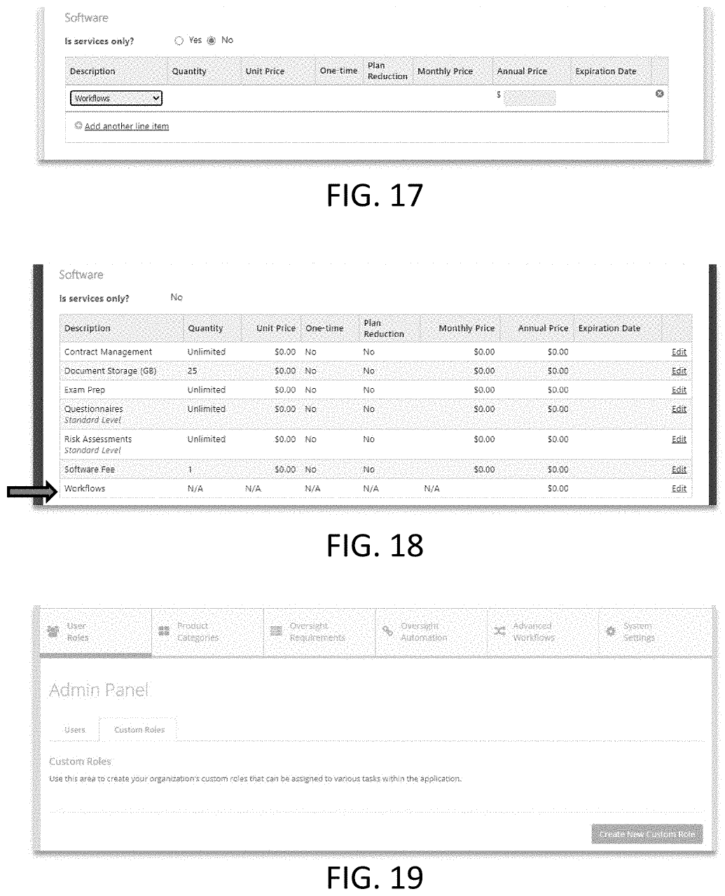

A Workflow module may be or include a billable module of the software. In the software section of a New Client Sale page, Workflows option may be added to the drop-down options. In some embodiments, this item may only require pricing for Annual Price. An example Sales & Contracting: New Sale GUI is shown in FIG. 17.

If a client user has Workflows as part of their purchase plan, the Workflow item will be shown in the Customer Order History details. An example Customer Order Details GUI is shown in FIG. 18

Administration Panel—User Roles

Client users that have Workflows in their purchase plan may also have the Custom Roles interface area available to them. These custom roles can be used when setting up workflows in the Advanced Workflows area. An example Admin Panel: User Roles—Custom Roles GUI is shown in FIG. 19.

Administration Panel—Advanced Workflows Tab

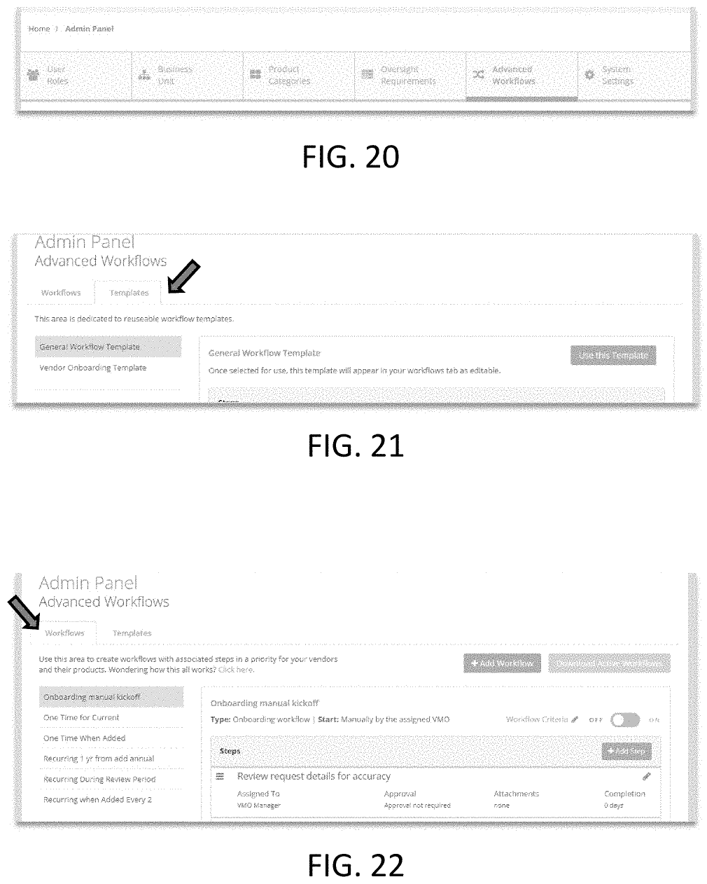

The Advanced Workflows module may be managed within an Admin Panel. In some embodiments, unlike other modules, this module may not have an all-encompassing on/off switch. Each workflow may be enabled/disabled independently. An example Admin Panel: Advanced Workflows Tab GUI is shown in FIG. 20.

Templates

The system may be preload example workflow templates for a client user. In some embodiments, a General Workflow Template may always be provided. If a client has the Vendor Onboarding module within their purchase plan, they may also see the Vendor Onboarding Template.

Within the provided system templates, the system may organize steps with consideration to the modules that the client has available within their purchase plan as well as the client's settings. In some embodiments, client users can neither edit nor order the steps within the system's Templates.

If a client elects to use a system Template, they may first setup the workflow criteria, and then system may create their workflow in the Workflows tab where users may further configure their workflow. An example Advanced Workflows: Templates GUI is shown in FIG. 21. Example Templates are listed in Table 5 and Table 6.

TABLE 5
General Workflow Template

| | |
|---|---|
| Complete vendor profile | |
| Complete product profile | |
| Upload contract | Purchase Plan dependent |
| Create SLA items | Purchase Plan dependent |
| Upload documents | |
| Send questionnaire | Purchase Plan dependent |
| Inherent risk assessment | Purchase Plan dependent |
| Assign oversight tasks | |
| Complete oversight tasks | |
| Residual risk assessment | Setting dependent |

TABLE 6
Vendor Onboarding Template

| | |
|---|---|
| Review request details for accuracy | |
| Assign Assessments Section | Purchase Plan dependent |
| Perform inherent risk assessment | Purchase Plan dependent |
| Perform residual risk assessment | Purchase Plan and setting |
| | dependent |
| Assign Diligence Section | |
| Assign due diligence tasks | |
| Complete due diligence tasks | |
| Assign Questionnaire Section | |
| Send questionnaires | |
| Assign Relationships Section | |
| Create fourth party relationships | |
| Collect due diligence | |
| documentation | |
| Assign Contracts section | |
| Upload Contract | |
| Assign Reference Section | |
| Approve or decline vendor | |

Workflows

In some embodiments, the Workflows tab interface is where a client user may manage their workflows. Workflows may be listed on the left, and clicking the title may display the steps within the workflow and allow for editing. A user may be able to create a new workflow and download their active workflows into a PDF from this area. An example Manage Workflows GUI is shown in FIG. 22.

Creating a Workflow

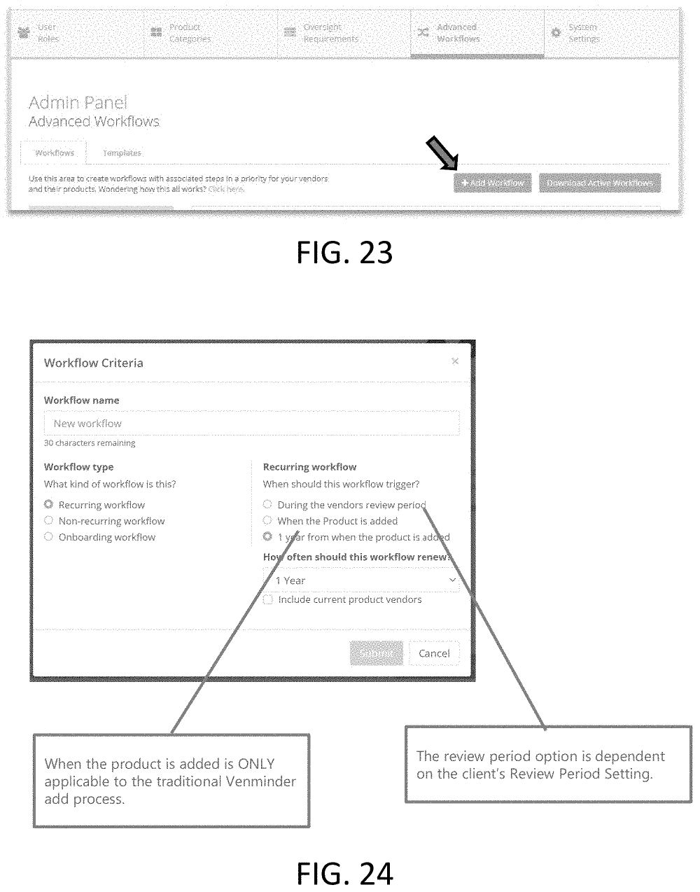

In some embodiments, when a user clicks the Add Workflow button, they may be prompted to setup the workflow criteria and then proceed to add steps. Steps may not be prepopulated from this location of creating a workflow. A user may start from scratch here but can use the system's Template steps from the add step function. A workflow may be added by clicking the Add Workflow button in the Manage Workflows GUI as shown in FIG. 23.

Workflow Criteria

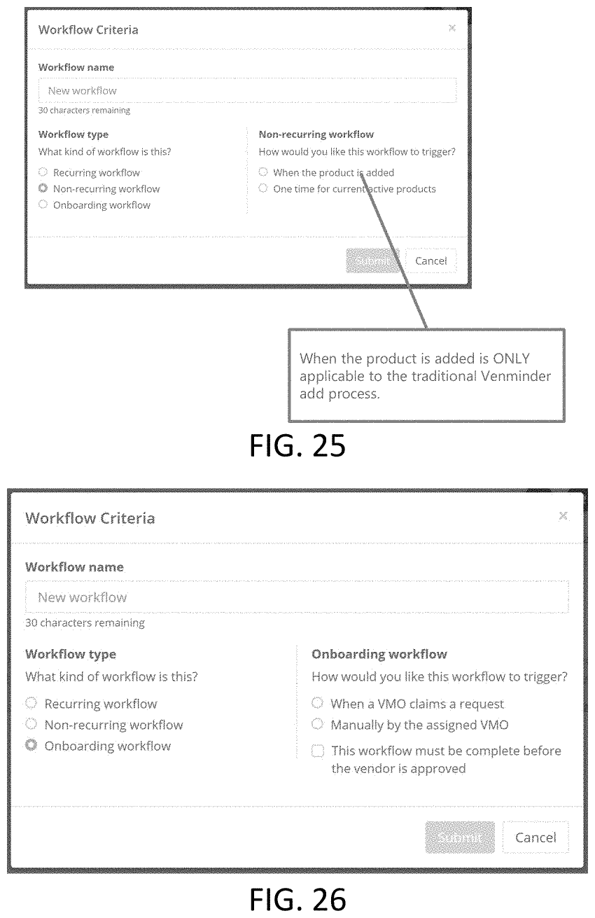

In some embodiments, when creating a general workflow, a client may enter a name of up to 30 characters in length. A user may choose for the workflow to be recurring or non-recurring. A user may choose when the workflow will be triggered and the frequency thereafter if recurring (e.g., 1, 2, or 3 years). Both options include the ability to apply the workflow to current products. An example Workflow Criteria—Recurring Workflow Criteria GUI is shown in FIG. 24. An example Workflow Criteria—Non-Recurring Workflow Criteria GUI is shown in FIG. 25.

In some embodiments, when creating an onboarding workflow, a client may enter a name up to 30 characters, select when the workflow gets triggered and if the workflow must be complete before being able to approve the vendor. An example Vendor Onboarding Workflow Criteria GUI is shown in FIG. 26.

After setting up the workflow criteria, the workflow may be created by the system and can be found in the Workflows tab, populated with the suggested steps, ready for the client user to configuring their workflow further.

Editing a Workflow

In some embodiments, edits made to an active workflow are only applied to future workflows. In some embodiments, what is experienced in app/outlined in the Vendor Dashboard or Vendor Onboarding Request can vary from what is defined in the Advanced Workflows tab of the Admin Panel.

In some embodiments, the following actions may be taken on a workflow:

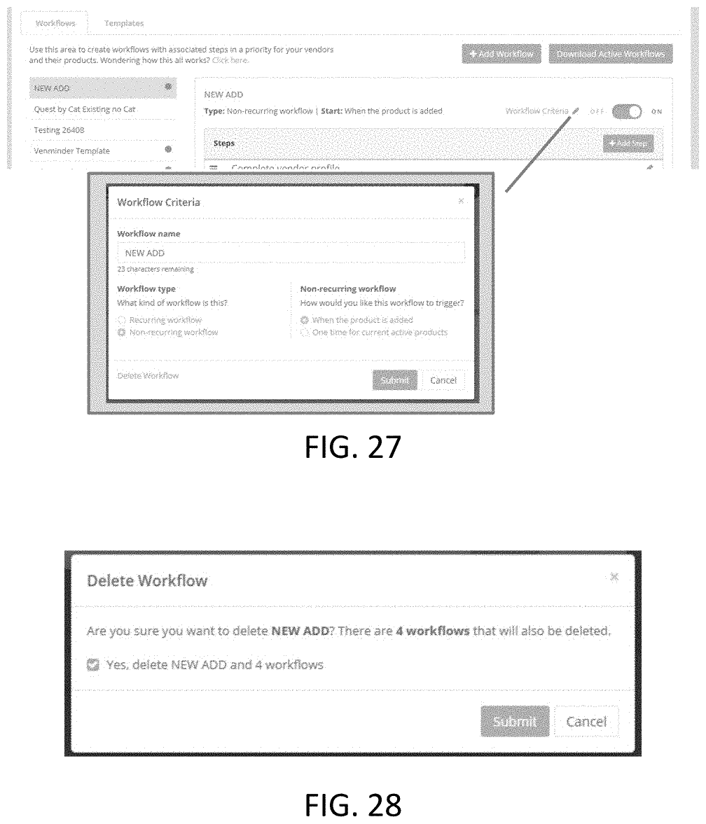

Edit the Name of the workflow: The name of the workflow may be edited from the Workflow Criteria module accessed by clicking the Workflow Criteria link/pencil. An example Workflow Criteria GUI as activated by the Workflow Criteria link/pencil is shown in FIG. 27.

Editing criteria to trigger the workflow: Modifying trigger criteria would only be available when the workflow template is turned OFF. Otherwise, fields to select workflow type and configurations are disabled.

Delete the Workflow

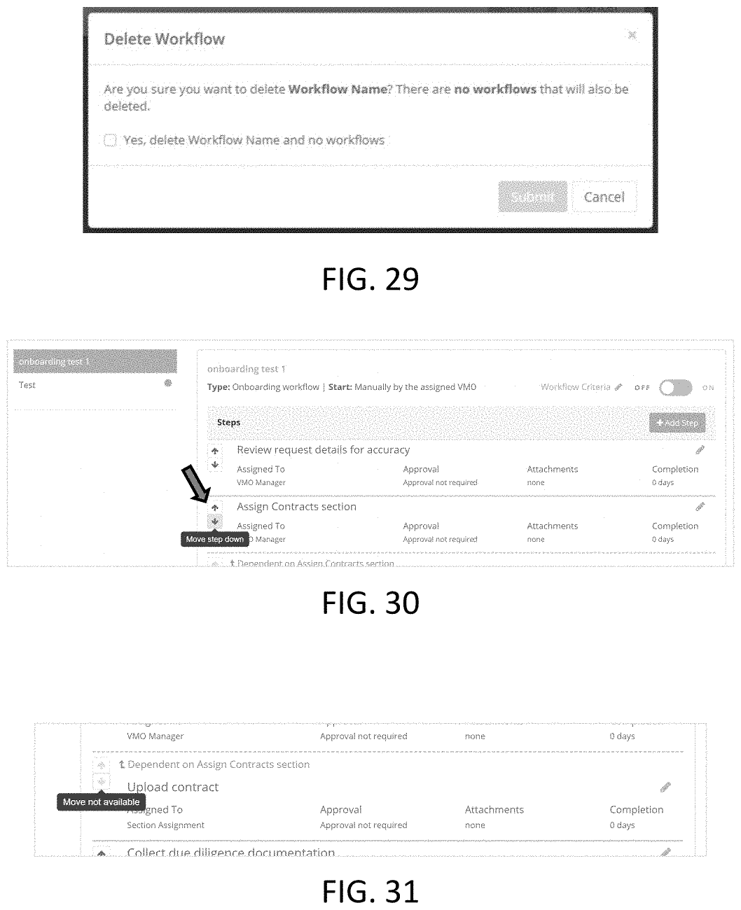

In some embodiments, a workflow can be deleted from the Workflow Criteria modal. The confirm delete modal widget may advise how many workflows will be deleted, e.g., workflows in progress, cancelled, and completed ones. An example Delete workflow widget to delete template and associated workflows is shown in FIG. 28. An example Delete workflow widget to delete template with no associated workflows triggered is shown in FIG. 29.

Reorder Steps within a Workflow

In some embodiments, steps can be reordered by clicking on arrow keys located on the left side of a workflow step. This option may be disabled when the workflow step does not have “sibling” steps within the hierarchy to swap positions. An example Workflow template: Move workflow step widget is shown in FIG. 30. An example Workflow template: Move option not available widget is shown in FIG. 31.

Adding a Step to the Workflow

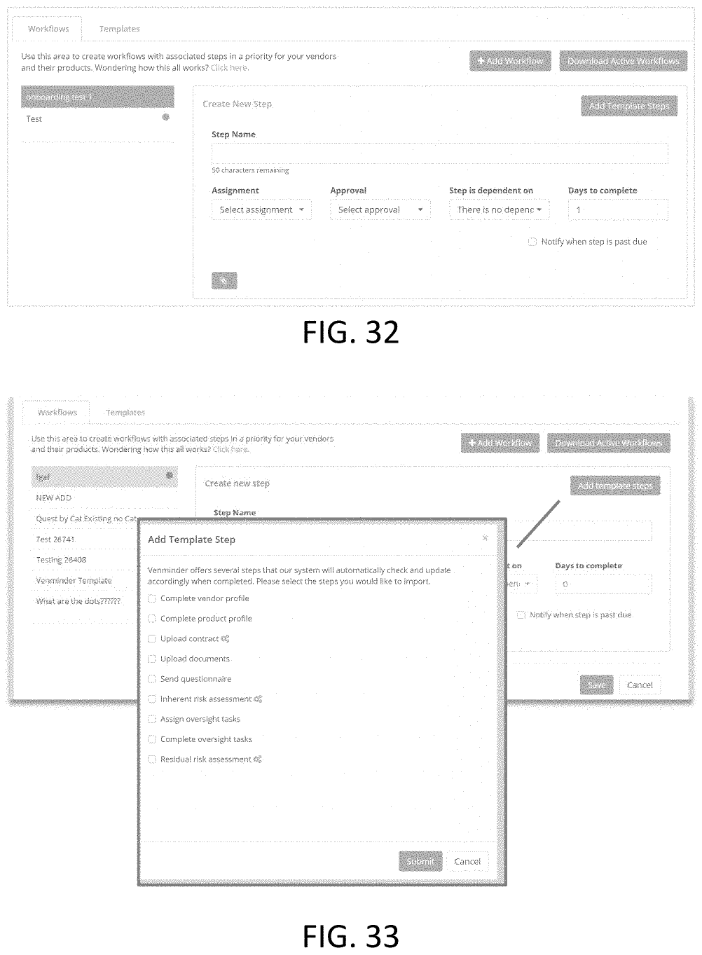

In some embodiments, the following information may be captured when adding a (custom) step to a workflow: Step Name (e.g., up to 50 characters long); Assignment options may include product manager, specific user, or custom role; Approval options may include that approval is not required, or may be provided by product manager, specific user, or custom role; Dependency options may include that a step is not dependent or that other steps already added can be selected; Days to complete may include 1 day to unlimited; Indication if notification when step is past due and, if so, who will be notified (options include product manager, specific user, or custom role); and capability to include an attachment. An example Workflow template: Add step GUI is shown in FIG. 32.

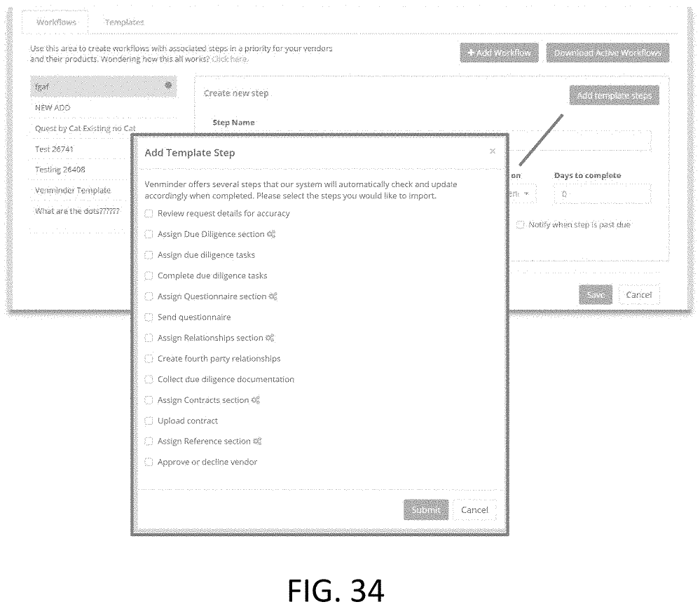

In some embodiments, an option may be provided to add template steps, which allows a user to select from system specific functionality with consideration to the modules that the client has available within their purchase plan as well as the client's settings. In some embodiments, using a template step will ‘lose’ any information entered in the ‘custom’ add step form. In some embodiments, Template Step is added to the bottom of the step list. In some embodiments, the system may prevent a user from adding a template step multiple times within the workflow; the only exception to that may be Send Questionnaire workflow step. An example Add template step for non-onboarding workflow GUI is shown in FIG. 33. An example Add template step for onboarding workflow GUI is shown in FIG. 34.

Questionnaire Template Steps

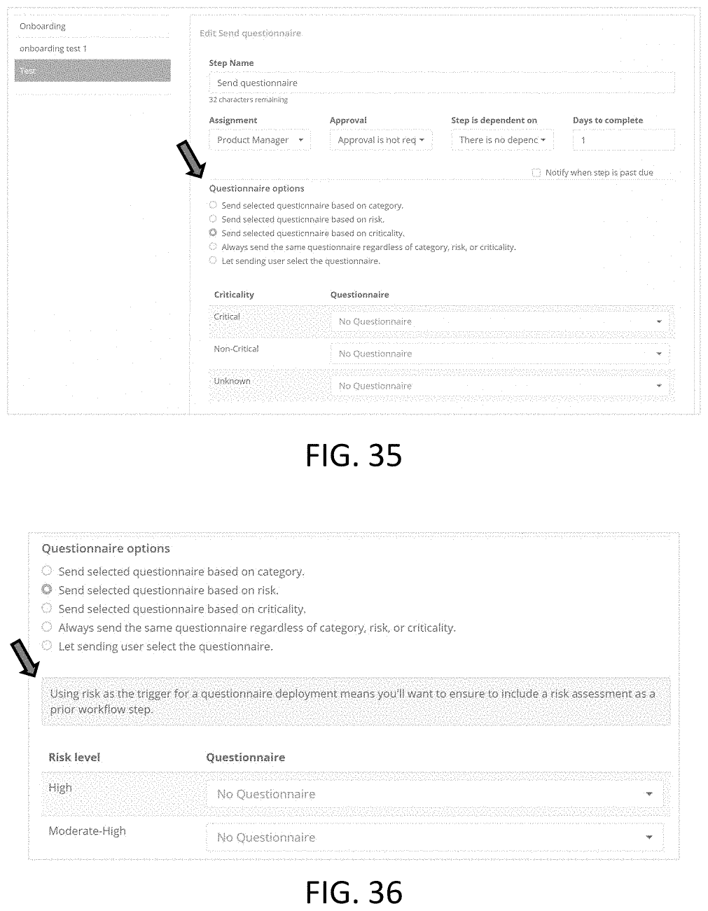

The system's template step for send questionnaire may require the client to select questionnaire options. An option may include sending a selected questionnaire based on category (requires Category Management to be on). An option may include sending a selected questionnaire based on risk. An option may include sending a selected questionnaire based on criticality. An option may include always sending the same questionnaire regardless of category, risk, or criticality. An option may include providing a sending user with the option to select the questionnaire. An example Edit Send questionnaire GUI is shown in FIG. 35.

If the send selected questionnaire based on risk option is chosen, guidance text may be provided advising that a risk assessment should be included as a prior workflow step. An example Questionnaire options GUI is shown in FIG. 36.

Onboarding Workflow: Assignment Template Steps

In some embodiments, Assignment template steps within an onboarding workflow may allow an administrator user to pre-define section owners and approvers for new vendor requests submitted for review. The following information may be captured when adding an assignment step to an onboarding workflow: Step Name (e.g., up to 50 characters); Section Assignment options (may include Vendor Management Office (VMO) Manager, Requestor, or specific user);

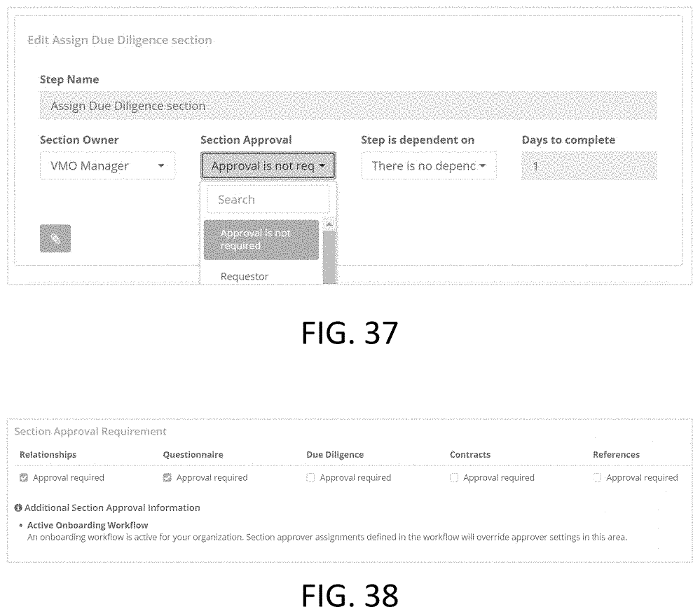

Section Approver (options include VMO Manager, Requestor, or specific user); Dependency options (may include that a step is not dependent or other steps already added can be selected); Days to complete (may be defaulted to 1); and Ability to include an attachment. An example Onboarding Workflow Template: Edit Assignment GUI is shown in FIG. 37.

In some embodiments, Section Approval Assignment steps may override onboarding template settings for approval. A message may be displayed in Onboarding settings when there is an active onboarding workflow that contains steps for section approval assignments. An example Onboarding Settings: Section Approval Override Warning widget is shown in FIG. 38.

Onboarding Workflow: Template Steps

In some embodiments, for other template steps that are not section auto-assignment steps, the system may set a default step owner to the section assignment, given the nature of the step. For example, a user assigned to the Questionnaires section may be permitted to send a questionnaire. Those steps without any section dependencies can continue to be assigned to an onboarding role, custom role, or specific user. A table illustrating Onboarding Workflow Template Steps and their respective dependencies is shown in Table 7.

TABLE 7

| Onboarding Workflow Template Step | Dependency |
|---|---|
| Review request details for accuracy | Assigned to VMO Manager |
| Assign due diligence tasks | Assigned to Due Diligence section |
| | assignment |
| Complete due diligence tasks | Assigned to Due Diligence section |
| | assignment |
| Send Questionnaire | Assigned to Questionnaires section |
| | assignment |
| Create fourth party relationships | Assigned to Relationships section |
| | assignment |
| Collect due diligence documentation | No dependencies |
| Upload contract | Assigned to Contracts section |
| | assignment |
| Approve or decline vendor | No dependencies |

Editing a Step within the Workflow

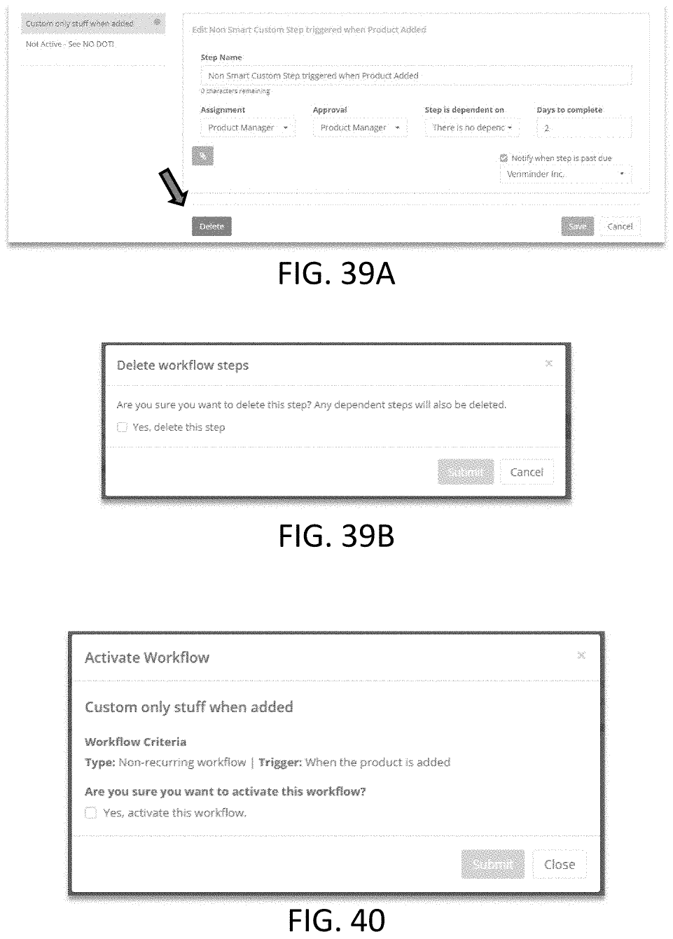

In some embodiments, editing a workflow steps prepopulates data and allows for edits. These functionalities may be the same as adding a step but with the ability to delete the step. Deleting a step ma delete any dependent steps associated. An example Edit Step widget with Delete button is shown in FIG. 39A. A corresponding Delete workflow steps widget is shown in FIG. 39B.

Turning the Workflow on

When a client user elects to turn on (activate) a workflow, they may be required to confirm their action. If a workflow is to be applied to a client's current list of active vendors, activating a workflow may not be instantaneous but may require an amount time. In some embodiments, the system may provide an additional prompt advising of the time to activation. An email may be generated and sent to the user when the workflow application has been completed. An example Activate Workflow GUI is shown in FIG. 40.

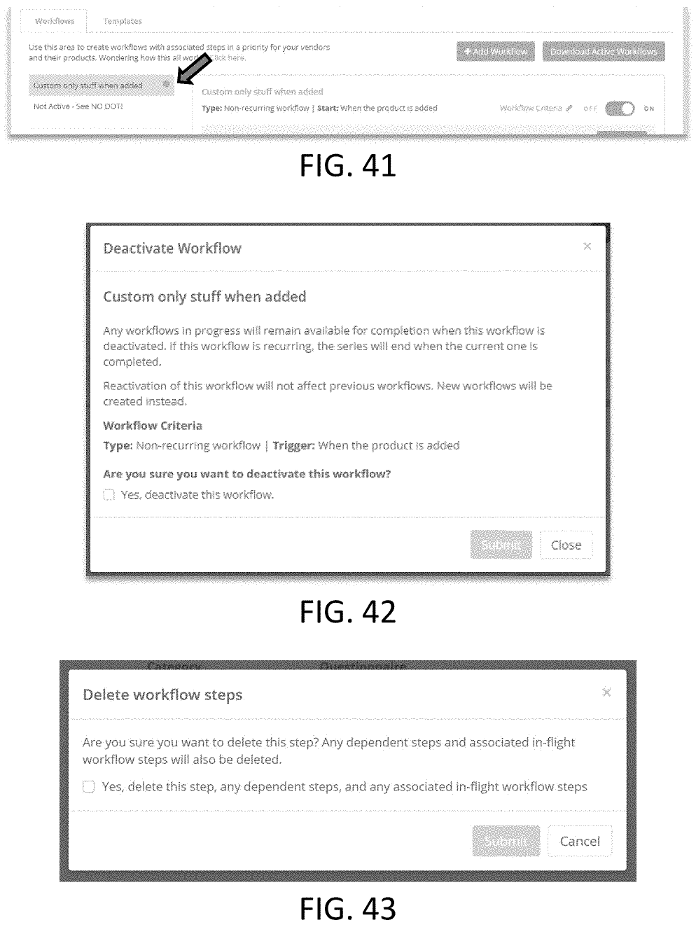

In some embodiments, when a workflow is on or active, a green (or other colored) dot to the right of the workflow name may be displayed on a Workflow GUI widget. An example Workflow GUI widget with a workflow activation indicator is shown in FIG. 41.

Once a workflow is turned on, it is applied accordingly. Work items may be managed from a new tab on the Vendor Dashboard. In the event of a Vendor Onboarding workflow, Work items may be managed from the Status tab of a Vendor Request.

In some embodiments, only one onboarding workflow may be active at a time.

This restriction may be applied to ensure that there will be no overlap in the auto-assignment of section owners and section approvers.

Turning the Workflow Off

In some embodiments, when a client user elects to turn off (deactivate) a workflow they may be required to confirm their action. Turning off a workflow may leave any inflight workflows so that they can be completed. In some embodiments, if the workflow is turned back on, a new workflow will be created. An example Deactivate Workflow GUI is shown in FIG. 42.

Deleting a Workflow Step

In some embodiments, deleting a workflow step from an active workflow may (quasi) delete all workflow steps from active workflows that utilize the corresponding template. Any dependent steps may also be deleted. A user may be required to confirm their action before the workflow step can be deleted. An example Delete workflow steps GUI is shown in FIG. 43.

Download Active Workflows

In some embodiments, clicking the Download Active Workflows button may create a PDF of all the client's currently active workflows. Downloads may be activated by clicking the Download Active Workflows button in the Manage Workflows GUI as shown in FIG. 44.

Main Dashboard

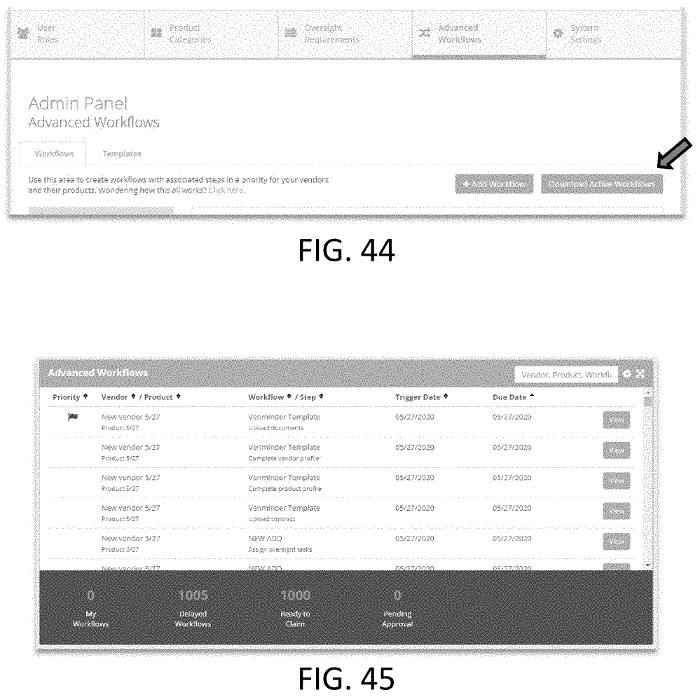

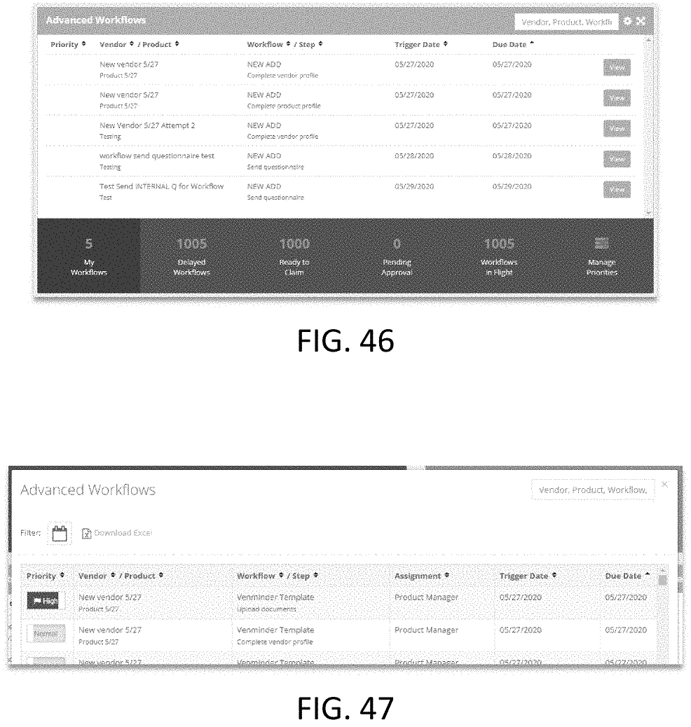

In some embodiments, an Advanced Workflows widget may be available to all users on the Main Dashboard. Like the other widgets, this new widget may provide the following: Search by vendor, product, or workflow; View/filter (e.g., Status, Workflow Type, Assignment, Set as default view option); Expanded View with a download to excel option; Sorting (column headers); Stats/Quick filtering (e.g., My Workflows, Delayed Workflows, Ready to Claim, Pending Approval, Workflows in Flight—Only available to Admin users). Admin users may be provided with a Manage Priorities option that opens the expanded view allowing them to mark a workflow as High Priority. A Main Dashboard: Advanced Workflows Widget for NON-Admins GUI is shown in FIG. 45. A Main Dashboard: Advanced Workflows Widget for Admins GUI is shown in FIG. 46. An Advanced Workflows Widget Expanded View for Admins GUI is shown in FIG. 47.

Vendor Dashboard

Workflow Status Widget

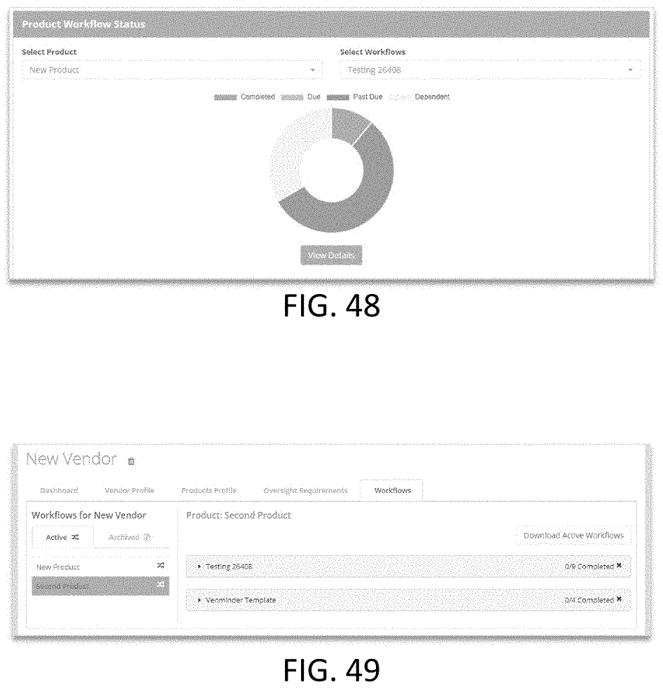

In some embodiments, a workflow status widget on the main tab of the vendor dashboard may provide client users with a status graph of all the current workflows in progress. Client users may be provided with the capabilities to filter down a view based on product and workflow. For a more detailed view, clicking a View Details button may navigate client users to the Workflows tab with the details opened for the selected product and workflow. An example Product Workflow Status widget is shown in FIG. 48.

Workflows Tab

The workflows tab on the Vendor Dashboard may provide a GUI from which all product workflows may managed. Workflows currently in progress may be found under the Active tab. An example Workflows Tab GUI is shown in FIG. 49.

Selecting a product may cause displaying a list of workflows in progress for that product (e.g., on the right side). A count of the number of steps completed may be provided. Only Admin users may be provided with the capability to cancel a workflow by clicking an appropriate button (X). Once the cancel action is confirmed, all steps in the corresponding workflow may be marked as cancelled and the workflow may move to the Archived tab. Client users may be provided with the capability to download a PDF of the current state of the active workflows for the product selected.

Clicking the workflow name may expand a widget to show all the steps within the workflow, including steps dependent on other steps. Buttons to take actions may be enabled or disabled based on any step dependencies and user permissions.

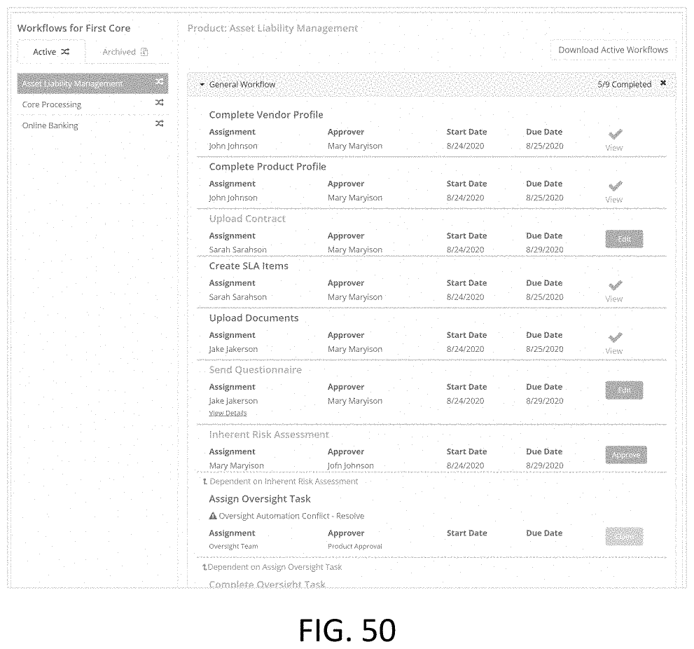

A table of available actions and corresponding permissions when a workflow step is available for work are shown in Table 8. An example Vendor Dashboard: Active workflow display GUI is shown in FIG. 50.

TABLE 8

| Action | Permission |
|---|---|
| Claim workflow step as assignment | Assigned user or users linked with |
| or approver | an assigned custom role, administrator |
| Edit workflow step | Assigned user, administrator |
| View workflow step | All users |
| Mark as complete, if approval not | Assigned user |
| required | |
| Approve workflow step | Assigned user |

Edit Workflow Step

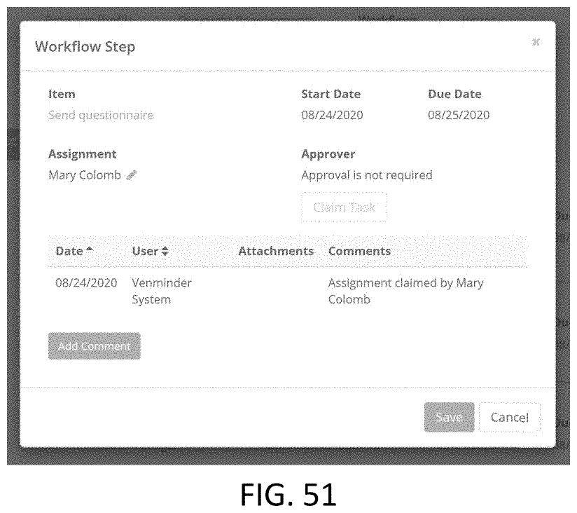

When editing a workflow step, a client user may be provided with the capability to reassign the step assignment and/or approver, and add comments. If the workflow step is a system-owned template step, the step name may be a hyperlink that will navigate the user to the appropriate area of the application to complete the action. An example Vendor Dashboard: Edit Workflow Step GUI is shown in FIG. 51.

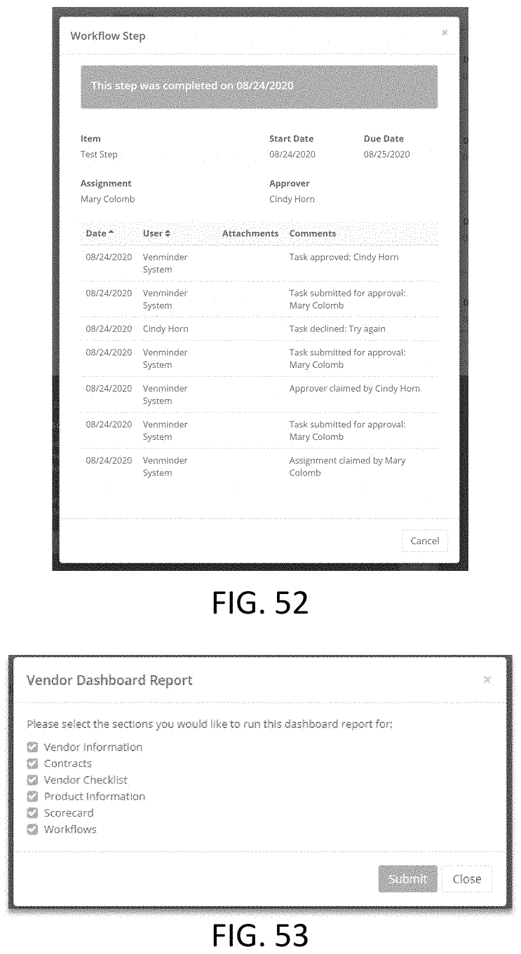

A system as described herein may also record a comment when key events occur within a workflow step. Activities include: when a workflow step is claimed by user or approver; when a workflow step is submitted for approval; when a workflow step approval is declined; or when a workflow step approval is approved. An example Workflow Step: Approval History in Comments GUI is shown in FIG. 52

Vendor Dashboard Report

A vendor dashboard report may provide a client user with the capability to configure what the user may want to see on the report. This functionality may be available to all clients, not just those who have access to the Workflows module. In some embodiments, tasks and Confidence Level may not be included on the report. In some embodiments, the Workflows module will only be an option if a client has the Workflows option in their purchase plan. An example Vendor Dashboard Report GUI is shown in FIG. 53.

Questionnaires

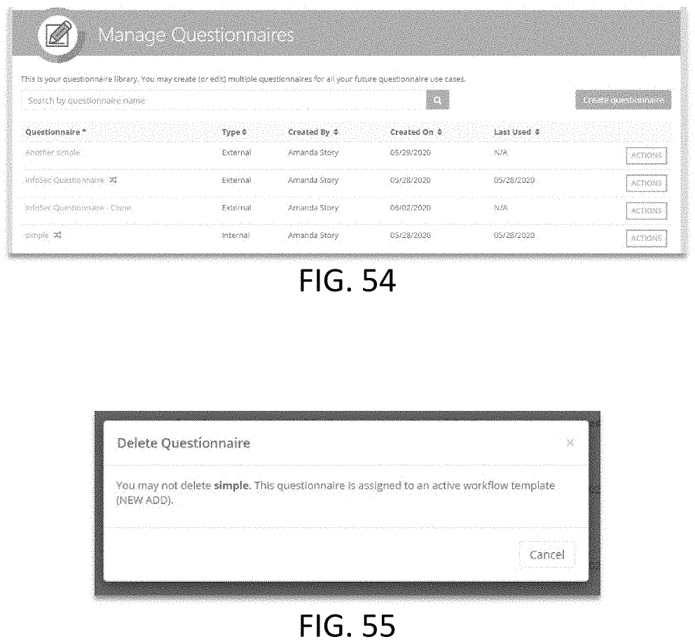

When a questionnaire is assigned to a workflow template, that questionnaire may be associated with a workflow indicator next to the Questionnaire Name. An example Questionnaires: Questionnaire Library GUI is shown in FIG. 54.

In some embodiments, questionnaires that are assigned to a workflow template cannot be deleted. An example Delete Questionnaire GUI is shown in FIG. 55.

Vendor Onboarding: Workflow

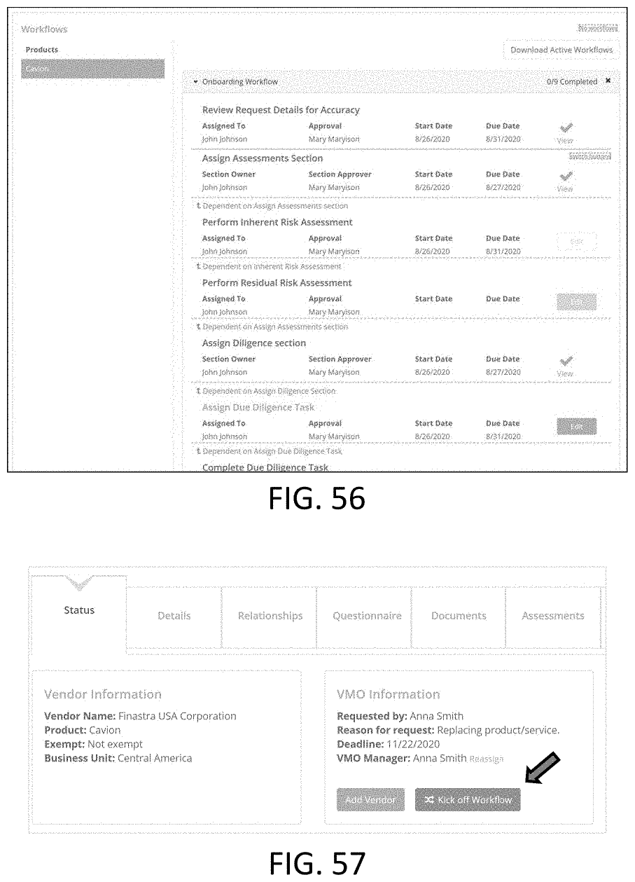

Onboarding workflow for a vendor request can be found on the Status tab of the vendor request view. An example Workflow window with Onboarding Workflow GUI is shown in FIG. 56

Onboarding Workflow Kickoff

If the onboarding workflow is configured to be manually triggered, the VMO Manager may be presented with a button to Kick off Workflow from the Status tab of the vendor request. Otherwise, the workflow may automatically kickoff when a request has been claimed/assigned to a VMO Manager. An example Status Tab with a Kick off Workflow button is shown in FIG. 57.

Managing the Onboarding Workflow

The workflow may be managed from a dedicated workflow section on the Status tab of the vendor request.

Section Assignment Workflow Steps

When an assignment-type workflow step is triggered, the system may automatically assign a section owner and a section approver, if applicable. At this time, the workflow step may also be marked as complete, triggering any dependent steps for work.

System-Owned Workflow Steps

Similar to workflow steps in non-onboarding workflows, any System-owned template steps may provide hyperlinks to navigate a client user to the appropriate vendor request section to complete their work. For example, clicking on a Send Questionnaire workflow step will navigate the user to the Questionnaires section of the vendor request to send the questionnaire.

Email Communication

Example emails that are associated with the Workflows module when and where applicable are shown in Table 9.

TABLE 9

| Email Template | Description | Trigger |
|---|---|---|
| | Notify user with a workflow assignment or | Early am after workflow |
| | approval role that a workflow step is available | is triggered (business |
| | to be claimed | days) |
| Workflow Step | Notify user with a workflow assignment or | Early am day after step |
| Past Due | approval role that a workflow step is past due | due date (business days) |
| Workflow Step | Notify user with a workflow approval role | Early am day after step |
| Submitted for | that a workflow step is ready for review. Also | is submitted for |
| Approval | sent to the user who submitted for approval | approval (business days) |
| | and the Product Manager | |
| Workflow Step | Notify user who submitted step for review | Early am day after step |
| Approved | that the step is approved, | is approved (business |
| | Also sent to user who approved the step and | days) |
| | the Product Manager | |
| Workflow Step | Notify user who submitted step for review | Early am day after step |
| Declined | that the step is declined, | is declined (business |
| | Also sent to user who declined the step and | days) |
| | the Product Manager | |
| Actions for Today | When a user is within a custom role | |
| | associated with workflow assignment or | |
| | approval | |
| | When the user is specifically assigned to do | |
| | the work or approve OR is the assigned | |
| | product manager they will see an available | |
| | workflow steps table and the associated step | |
| | will be listed | |

Exemplary Network Environment and Computing Device

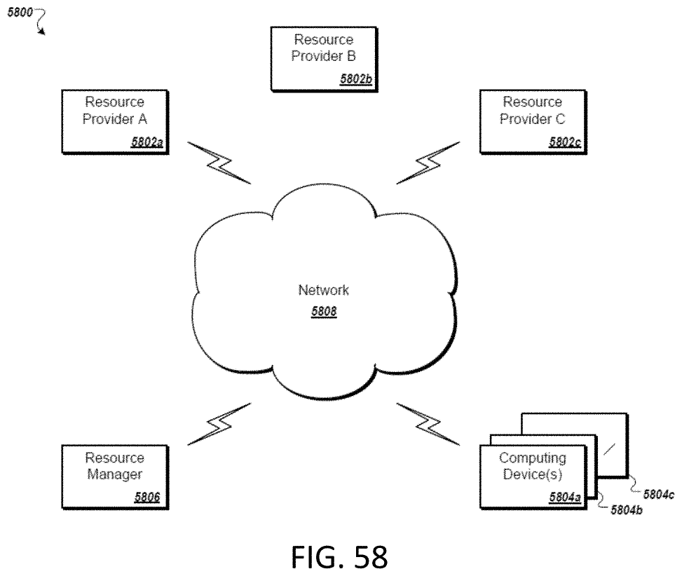

FIG. 58 shows an illustrative network environment 5800 for use in the methods and systems described herein. In brief overview, referring now to FIG. 58, a block diagram of an exemplary cloud computing environment 5800 is shown and described. The cloud computing environment 5800 may include one or more resource providers 5802a, 5802b, 5802c (collectively, 5802). Each resource provider 5802 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 5802 may be connected to any other resource provider 5802 in the cloud computing environment 5800. In some implementations, the resource providers 5802 may be connected over a computer network 5808. Each resource provider 5802 may be connected to one or more computing device 5804a, 5804b, 5804c (collectively, 5804), over the computer network 5808.

The cloud computing environment 5800 may include a resource manager 5806. The resource manager 5806 may be connected to the resource providers 5802 and the computing devices 5804 over the computer network 5808. In some implementations, the resource manager 5806 may facilitate the provision of computing resources by one or more resource providers 5802 to one or more computing devices 5804. The resource manager 5806 may receive a request for a computing resource from a particular computing device 5804. The resource manager 5806 may identify one or more resource providers 5802 capable of providing the computing resource requested by the computing device 5804. The resource manager 5806 may select a resource provider 5802 to provide the computing resource. The resource manager 5806 may facilitate a connection between the resource provider 5802 and a particular computing device 5804. In some implementations, the resource manager 5806 may establish a connection between a particular resource provider 5802 and a particular computing device 5804. In some implementations, the resource manager 5806 may redirect a particular computing device 5804 to a particular resource provider 5802 with the requested computing resource.

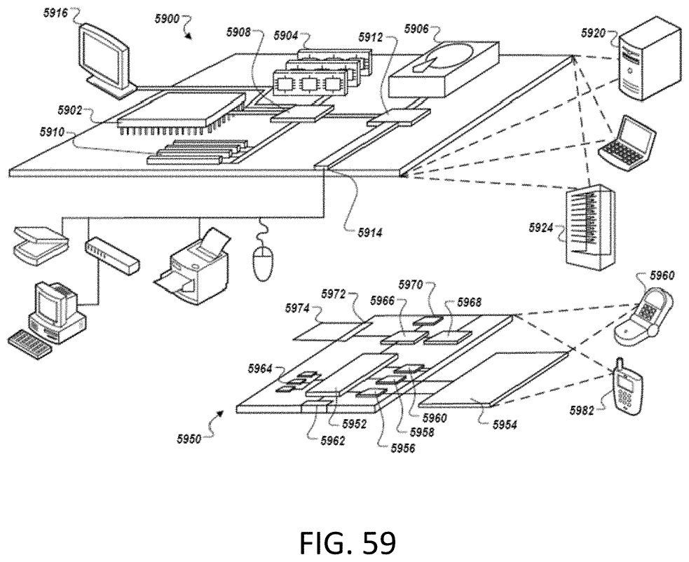

FIG. 59 shows an example of a computing device 5900 and a mobile computing device 5950 that can be used in the methods and systems described in this disclosure. The computing device 5900 is intended to represent various forms of digital computers, such as laptops, desktops, workstations, personal digital assistants, servers, blade servers, mainframes, and other appropriate computers. The mobile computing device 5950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 5900 includes a processor 5902, a memory 5904, a storage device 5906, a high-speed interface 5908 connecting to the memory 5904 and multiple high-speed expansion ports 5910, and a low-speed interface 5912 connecting to a low-speed expansion port 5914 and the storage device 5906. Each of the processor 5902, the memory 5904, the storage device 5906, the high-speed interface 5908, the high-speed expansion ports 5910, and the low-speed interface 5912, are interconnected using various busses, and may be mounted on a common motherboard or in other manners as appropriate. The processor 5902 can process instructions for execution within the computing device 5900, including instructions stored in the memory 5904 or on the storage device 5906 to display graphical information for a GUI on an external input/output device, such as a display 5916 coupled to the high-speed interface 5908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 5904 stores information within the computing device 5900. In some implementations, the memory 5904 is a volatile memory unit or units. In some implementations, the memory 5904 is a non-volatile memory unit or units. The memory 5904 may also be another form of computer-readable medium, such as a magnetic or optical disk.

The storage device 5906 is capable of providing mass storage for the computing device 5900. In some implementations, the storage device 5906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 5902), perform one or more methods, such as those described above. The instructions can also be stored by one or more storage devices such as computer- or machine-readable mediums (for example, the memory 5904, the storage device 5906, or memory on the processor 5902).

The high-speed interface 5908 manages bandwidth-intensive operations for the computing device 5900, while the low-speed interface 5912 manages lower bandwidth-intensive operations. Such allocation of functions is an example only. In some implementations, the high-speed interface 5908 is coupled to the memory 5904, the display 5916 (e.g., through a graphics processor or accelerator), and to the high-speed expansion ports 5910, which may accept various expansion cards (not shown). In the implementation, the low-speed interface 5912 is coupled to the storage device 5906 and the low-speed expansion port 5914. The low-speed expansion port 5914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 5900 may be implemented in a number of different forms, as shown in the figure. For example, it may be implemented as a standard server 5920, or multiple times in a group of such servers. In addition, it may be implemented in a personal computer such as a laptop computer 5922. It may also be implemented as part of a rack server system 5924. Alternatively, components from the computing device 5900 may be combined with other components in a mobile device (not shown), such as a mobile computing device 5950. Each of such devices may contain one or more of the computing device 5900 and the mobile computing device 5950, and an entire system may be made up of multiple computing devices communicating with each other.

The mobile computing device 5950 includes a processor 5952, a memory 5964, an input/output device such as a display 5954, a communication interface 5966, and a transceiver 5968, among other components. The mobile computing device 5950 may also be provided with a storage device, such as a micro-drive or other device, to provide additional storage. Each of the processor 5952, the memory 5964, the display 5954, the communication interface 5966, and the transceiver 5968, are interconnected using various buses, and several of the components may be mounted on a common motherboard or in other manners as appropriate.

The processor 5952 can execute instructions within the mobile computing device 5950, including instructions stored in the memory 5964. The processor 5952 may be implemented as a chipset of chips that include separate and multiple analog and digital processors. The processor 5952 may provide, for example, for coordination of the other components of the mobile computing device 5950, such as control of user interfaces, applications run by the mobile computing device 5950, and wireless communication by the mobile computing device 5950.

The processor 5952 may communicate with a user through a control interface 5958 and a display interface 5956 coupled to the display 5954. The display 5954 may be, for example, a TFT (Thin-Film-Transistor Liquid Crystal Display) display or an OLED (Organic Light Emitting Diode) display, or other appropriate display technology. The display interface 5956 may comprise appropriate circuitry for driving the display 5954 to present graphical and other information to a user. The control interface 5958 may receive commands from a user and convert them for submission to the processor 5952. In addition, an external interface 5962 may provide communication with the processor 5952, so as to enable near area communication of the mobile computing device 5950 with other devices. The external interface 5962 may provide, for example, for wired communication in some implementations, or for wireless communication in other implementations, and multiple interfaces may also be used.

The memory 5964 stores information within the mobile computing device 5950. The memory 5964 can be implemented as one or more of a computer-readable medium or media, a volatile memory unit or units, or a non-volatile memory unit or units. An expansion memory 5974 may also be provided and connected to the mobile computing device 5950 through an expansion interface 5972, which may include, for example, a SIMM (Single In Line Memory Module) card interface. The expansion memory 5974 may provide extra storage space for the mobile computing device 5950, or may also store applications or other information for the mobile computing device 5950. Specifically, the expansion memory 5974 may include instructions to carry out or supplement the processes described above, and may include secure information also. Thus, for example, the expansion memory 5974 may be provided as a security module for the mobile computing device 5950, and may be programmed with instructions that permit secure use of the mobile computing device 5950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 5952), perform one or more methods, such as those described above. The instructions can also be stored by one or more storage devices, such as one or more computer- or machine-readable mediums (for example, the memory 5964, the expansion memory 5974, or memory on the processor 5952). In some implementations, the instructions can be received in a propagated signal, for example, over the transceiver 5968 or the external interface 5962.

The mobile computing device 5950 may communicate wirelessly through the communication interface 5966, which may include digital signal processing circuitry where necessary. The communication interface 5966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 5968 using a radio-frequency. In addition, short-range communication may occur, such as using a Bluetooth®, Wi-Fi™, or other such transceiver (not shown). In addition, a GPS (Global Positioning System) receiver module 5970 may provide additional navigation- and location-related wireless data to the mobile computing device 5950, which may be used as appropriate by applications running on the mobile computing device 5950.

The mobile computing device 5950 may also communicate audibly using an audio codec 5960, which may receive spoken information from a user and convert it to usable digital information. The audio codec 5960 may likewise generate audible sound for a user, such as through a speaker, e.g., in a handset of the mobile computing device 5950. Such sound may include sound from voice telephone calls, may include recorded sound (e.g., voice messages, music files, etc.) and may also include sound generated by applications operating on the mobile computing device 5950.

The mobile computing device 5950 may be implemented in a number of different forms, as shown in the figure. For example, it may be implemented as a cellular telephone 5980. It may also be implemented as part of a smart-phone 5982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for managing one or more vendors and/or products, the method comprising the steps of:
causing to display, by a processor of an enterprise system, one or more graphical user interfaces (GUIs) associated with one or more workflow management modules,
receiving, by the processor of the enterprise system, a first input from a first client user, the first input comprising instructions to access a workflow management GUI;
receiving, by the processor of the enterprise system, data field information related to said vendor and/or product,
updating, in a memory of the enterprise system, vendor and/or product information stored in association with the first client, based on the subsequent input;
wherein the workflow management module is configured to produce and edit one or more vendor management workflow programs.

2. The method of claim 1, wherein the subsequent input comprises data field information for adding a step to a workflow.

3. The method of claim 2, wherein the step is a template step.

4. The method of claim 2, wherein the step is or includes a send questionnaire step.

5. The method of claim 1, wherein the workflow comprises an onboarding workflow.

6. The method of claim 1, wherein the workflow management module is user activated.

7. The method of claim 1, comprising downloading a workflow.

8. The method of claim 1, wherein each of the first input and the data field information is received via a graphical user interface widget.

9. The method of claim 8, wherein the first client user is one member of a network of subscribed clients authorized to access the enterprise system.

10. The method of claim 9, wherein the processor comprises at least one application-specific integrated circuit (ASIC) configured to execute at least one function of the vendor request module.

11. The method of claim 1, comprising creating an onboarding workflow.

12. The method of claim 11, wherein creating an onboarding workflow comprises:
entering, by the first client user, a name up to 30 characters;
selecting, by the first client user, when the onboarding workflow gets triggered; and
selecting, by the first client user, if the onboarding workflow must be complete before being able to approve the one or more vendors.

13. The method of claim 6, wherein the workflow management module is configured to produce and edit one or more vendor management workflow programs.

14. The method of claim 4, wherein the send questionnaire step comprises requiring the first client user to select questionnaire options.

15. The method of claim 14, wherein the questionnaire options comprise sending a selected questionnaire based on category.

16. The method of claim 14, wherein the questionnaire options comprise sending a selected questionnaire based on risk.

17. The method of claim 14, wherein the questionnaire options comprise sending a selected questionnaire based on criticality.

18. The method of claim 14, wherein the questionnaire options comprise always sending the same questionnaire regardless of category, risk, or criticality.

19. The method of claim 14, wherein the questionnaire options comprise providing the first client user with the option to select the questionnaire.

20. The method of claim 16, wherein sending a selected questionnaire based on risk comprises providing guidance text, wherein the guidance text comprises advising the first client user that a risk assessment should be included as a prior workflow step.
